(19) United States
(12) Patent Application Publication
(10) Pub. No.: US 2026/0258269 A1
(43) Pub. Date: Sep. 3, 2026

(54) Ink Jet Ink Set And Ink Jet Recording Method

(71) Applicant: SEIKO EPSON CORPORATION, Tokyo (JP)

(72) Inventor: Ryota IMAI, Shiojiri (JP)

(21) Appl. No.: 19/552,320

(22) Filed: Feb. 27, 2026

(30) Foreign Application Priority Data
Feb. 28, 2025 (JP) 2025-031284

(51) Int. Cl. C09D 11/40; B41M 3/00; C09D 11/037; C09D 11/102; C09D 11/107; C09D 11/322; C09D 11/324; D06P 1/00; D06P 1/52; D06P 5/30

(52) U.S. Cl. CPC C09D 11/40; B41M 3/008; C09D 11/037; C09D 11/102; C09D 11/107; C09D 11/322; C09D 11/324; D06P 1/0076; D06P 1/525; D06P 1/5285; D06P 5/30

(57) ABSTRACT

An ink jet ink set including a first ink jet ink and a second ink jet ink, in which the first ink jet ink contains a first pigment containing a black pigment, a first binder resin containing anionic acrylic resin particles, an organic solvent, and water, a content of the first pigment is 3% by mass or more with respect to a total amount of the first ink jet ink, a content of the anionic acrylic resin particles is 3% by mass or more with respect to the total amount of the first ink jet ink, the anionic acrylic resin particles are only resin particles having a largest content in the first binder resin, the second ink jet ink contains a second pigment containing a blue pigment, a second binder resin containing anionic urethane resin particles, an organic solvent, and water, a content of the second pigment is 3% by mass or more with respect to a total amount of the second ink jet ink, a content of the anionic urethane resin particles is 5% by mass or more with respect to the total amount of the second ink jet ink, and the anionic urethane resin particles are only resin particles having a largest content in the second binder resin.

The present application is based on, and claims priority from JP Application Serial Number 2025-031284, filed Feb. 28, 2025, the disclosure of which is hereby incorporated by reference herein in its entirety.

### BACKGROUND

### 1. Technical Field

The present disclosure relates to an ink jet ink set and an ink jet recording method.

### 2. Related Art

Ink jet recording methods enable recording of high-definition images with a relatively simple device and are developing rapidly in various fields. Among them, various studies are under progress regarding the friction fastness of formed images and the like. For example, JP-A-2023-088510 discloses a technique of applying a coating liquid containing no coloring material onto an aqueous ink containing a pigment to improve the friction fastness.

However, in the technique disclosed in JP-A-2023-088510, the brightness of images tends to increase due to the coating liquid, and it is thus difficult to obtain black images having a high optical density (OD) value. Therefore, there is a demand for a technique enabling the formation of an image in which both friction fastness and black color developability are satisfied.

### SUMMARY

According to an aspect of the present disclosure, an ink jet ink set includes a first ink jet ink and a second ink jet ink, in which the first ink jet ink contains a first pigment containing a black pigment, a first binder resin containing anionic acrylic resin particles, an organic solvent, and water, a content of the first pigment is 3% by mass or more with respect to a total amount of the first ink jet ink, a content of the anionic acrylic resin particles is 3% by mass or more with respect to the total amount of the first ink jet ink, the anionic acrylic resin particles are only resin particles having a largest content in the first binder resin, the second ink jet ink contains a second pigment containing a blue pigment, a second binder resin containing anionic urethane resin particles, an organic solvent, and water, a content of the second pigment is 3% by mass or more with respect to a total amount of the second ink jet ink, a content of the anionic urethane resin particles is 5% by mass or more with respect to the total amount of the second ink jet ink, and the anionic urethane resin particles are only resin particles having a largest content in the second binder resin.

According to an aspect of the present disclosure, an ink jet recording method using the above-described ink jet ink set includes a first ink attachment step of ejecting a first ink jet ink by an ink jet method and attaching the first ink jet ink to a recording medium, and a second ink attachment step of ejecting a second ink jet ink by the ink jet method and attaching the second ink jet ink to the recording medium, in which the first ink attachment step and the second ink attachment step are performed on the same region on the recording medium.

### BRIEF DESCRIPTION OF THE DRAWINGS

FIG. 1 is a diagram illustrating an example of a serial type ink jet recording device.

FIG. 2 is a table illustrating results of Examples.

FIG. 3 is a table illustrating results of Examples.

### DESCRIPTION OF EMBODIMENTS

Hereinafter, an embodiment of the present disclosure (hereinafter referred to as “the present embodiment”) will be described in detail with reference to the accompanying drawings as necessary, but the present disclosure is not limited thereto, and various modifications can be made within a range not departing from the gist thereof. In the drawings, the same elements are denoted by the same reference numerals and the repetitive description will be omitted. In addition, the positional relationships, such as the left, the right, the top, and the bottom, are based on the positional relationships illustrated in the drawings unless particularly otherwise specified. Furthermore, the dimensional ratios in the drawings are not limited to ratios illustrated in the drawings.

In the present embodiment, “ink jet ink” will also be simply referred to as “ink”. For example, “ink jet ink set” will also be referred to as “ink set”, “first ink jet ink” will also be referred to as “first ink”, and “second ink jet ink” will also be referred to as “second ink”. 1. Ink Jet Ink Set

An ink set of the present embodiment includes a first ink and a second ink. The first ink contains a first pigment containing a black pigment, a first binder resin containing anionic acrylic resin particles, an organic solvent, and water. The content of the first pigment is 3% by mass or more with respect to the total amount of the first ink. The content of the anionic acrylic resin particles is 3% by mass or more with respect to the total amount of the first ink. The anionic acrylic resin particles are the only resin particles having the largest content in the first binder resin. The second ink contains a second pigment containing a blue pigment, a second binder resin containing anionic urethane resin particles, an organic solvent, and water. The content of the second pigment is 3% by mass or more with respect to the total amount of the second ink. The content of the anionic urethane resin particles is 5% by mass or more with respect to the total amount of the second ink. The anionic urethane resin particles are the only resin particles having the largest content in the second binder resin.

Urethane resins relatively easily aggregate and thus tend to improve the friction fastness of coating films to be obtained. On the other hand, urethane resins easily shrink and thus tend to degrade the smoothness of the coating films to be obtained. As a result, light that passes through the coating films is likely to be scattered, which causes black color developability to deteriorate. For such reasons, it is difficult to satisfy both the friction fastness and the black color developability when urethane resins are singly used.

On the other hand, acrylic resins have high transparency and favorable film-forming properties and thus tend to improve the smoothness of the coating films to be obtained. Therefore, a coating film in which light is less likely to be scattered can be obtained by acrylic resins. In addition, acrylic resins are relatively less likely to aggregate, promote the wetting and spreading of ink, and tend to improve ink coverage in recording media. As described above, acrylic resins enable the formation of coating films having low scattering properties and favorable coverage, and there is thus a tendency that images having high black color developability can be obtained as compared with urethane resins. On the other hand, acrylic resins are less likely to aggregate, and there is thus a tendency that the friction fastness of coating films to be obtained is lower as compared with that of coating films obtained from urethane resins. For such reasons, it is also difficult to satisfy both the friction fastness and the black color developability when acrylic resins are singly used.

In addition, it is still difficult to satisfy both the friction fastness and the black color developability even when a urethane resin and an acrylic resin are jointly used in one ink. This is presumed to be because, when a urethane resin and an acrylic resin are contained in one ink in the same quantities, the two resins are likely to be present in a state of being uniformly mixed in coating films of the ink, and the performances of both resins are offset. In addition, when both a urethane resin and an acrylic resin are incorporated into one ink, there is a problem in that the storage stability of the ink deteriorates.

In contrast, in the present embodiment, the first ink containing the anionic acrylic resin particles the most as the binder resin and the second ink containing the anionic urethane resin particles the most as the binder resin are separately used as a set. With this configuration, the present embodiment enables the formation of an image in which both the friction fastness and the black color developability are satisfied. The reason for this is presumed to be as follows. When a coating film is formed with the first ink rich in an acrylic resin and the second ink rich in a urethane resin, the acrylic resin and the urethane resin are present in the coating film in a somewhat independent state, respectively. This prevents the acrylic resin and the urethane resin from being mixed too much, whereby the performances of both resins are less likely to be offset, and both the friction fastness and the black color developability are thus satisfied. This mechanism for exhibiting this effect is a presumption, and the mechanism for exhibiting the effect of the present embodiment is not limited thereto.

In addition, the ink set of the present embodiment is preferably a set of a first ink that is a black ink and a second ink that is a blue ink. In this configuration, the first ink and the second ink are jointly used, and the black color developability thereby tends to further improve.

The ink set of the present embodiment is not particularly limited, but is preferably for textile printing. Fabrics tend to be highly permeable to ink, and it is thus difficult to satisfy both friction fastness and black color developability, but the ink set of the present embodiment enables both the friction fastness and the black color developability to be achieved even in textile printing in which the ink set is printed on fabrics.

### 1.1. First Ink Jet Ink

The first ink contains a first pigment containing a black pigment, a first binder resin containing anionic acrylic resin particles, an organic solvent, and water. From the viewpoint of improving the black color developability of images, the first ink is preferably a black ink. In the present embodiment, “black ink” refers to an ink for which L^{*} is 50 or less, a* is 10 or less, and b* is 10 or less in a Lab color space of a printed image obtained by a predetermined printing method. The predetermined printing method is as follows. The ink is ejected onto a fabric using an ink jet printer. The printing resolution is set to 1440×720 dpi, the ink laydown is set to 22 ng/dot, and the amount of the ink applied is set to 22.8 mg/inch². The fabric on which the image is recorded is dried at 160° C. for three minutes to obtain a printed image.

### 1.1.1. First Pigment

The first pigment contains a black pigment. The first pigment may contain a pigment other than the black pigment. However, since the first ink is preferably a black ink, the first pigment preferably does not contain a pigment other than the black pigment. When the first pigment also contains a pigment other than the black pigment, the black pigment is preferably contained as a pigment having the largest content on its own in the first pigment.

Examples of the black pigment include carbon blacks (C. I. Pigment Black 7) such as furnace black, lamp black, acetylene black, and channel black, metals such as a copper oxide and an iron oxide (C. I. Pigment Black 11), and organic pigments such as aniline black (C. I. Pigment Black 1). Among these, carbon black is preferable as the black pigment. The carbon black has a relatively low specific gravity and is less likely to be precipitated in the ink.

The black pigment may be self-dispersible or resin-dispersible, but is preferably self-dispersible. Self-dispersible black pigments are likely to improve the black color developability of images as compared with resin-dispersible black pigments. In the present embodiment, “self-dispersible” refers to a type of pigment that disperses on its own even when not present with a dispersant or the like. In contrast, “resin-dispersible” refers to a type of pigment that is dispersed by a resin dispersant. The resin dispersant that disperses pigments is defined as not corresponding to the “binder resin” in the present embodiment. The black pigment is particularly preferably self-dispersible carbon black.

The content of the first pigment is 3% by mass or more and preferably 4% by mass or more or 5% by mass or more with respect to the total amount of the first ink. With such a content, the black color developability of images tends to further improve. The content of the first pigment is preferably 10% by mass or less or 8% by mass or less with respect to the total amount of the first ink.

### 1.1.2. First Binder Resin

The first binder resin contains the anionic acrylic resin particles as the only resin particles having the largest content in the first binder resin. “The only resin particles having the largest content in the first binder resin” can also be rephrased as “resin particles having the largest content on their own in the first binder resin”. That is, the first binder resin may contain resin particles other than the anionic acrylic resin particles, but the content of the resin particles is smaller than the content of the anionic acrylic resin particles.

Let's say when the ink contains 50 parts by mass of the anionic acrylic resin particles and 50 parts by mass of the resin particles other than the anionic acrylic resin particles in 100 parts by mass of the binder resin, there are two resin particles having the largest content, and there is no “only resin particles having the largest content”, and the above-described requirement is thus determined not to be satisfied.

Examples of an acrylic resin that configures the acrylic resin particle include resins obtained by polymerizing (meth)acrylic monomers such as (meth)acrylic acid or (meth)acrylic acid ester and resins obtained by copolymerizing a (meth)acrylic monomer and another monomer.

The acrylic resin particle is anionic, whereby the dispersion stability tends to further improve. The anionic acrylic resin particle has, for example, a carboxy group, a sulfo group, a hydroxy group, or the like.

The content of the anionic acrylic resin particles is 3% by mass or more and preferably 4% by mass or more or 5% by mass or more with respect to the total amount of the first ink. With such a content, the friction fastness of images tends to further improve. In addition, the content of the anionic acrylic resin particles is preferably 12% by mass or less, 10% by mass or less, or 8% by mass or less with respect to the total amount of the first ink. With such a content, the black color developability of images tends to further improve.

The content of the first binder resin is preferably 12% by mass or less, 10% by mass or less, or 8% by mass or less with respect to the total amount of the first ink. With such a content, the ejection stability and the black color developability of images tend to further improve. In addition, the content of the first binder resin is preferably 3% by mass or more, 4% by mass or more, or 5% by mass or more with respect to the total amount of the first ink. With such a content, the friction fastness of images tends to further improve.

The total content of the first pigment and the first binder resin is preferably 17% by mass or less, 15% by mass or less, or 13% by mass or less with respect to the total amount of the first ink. With such a total content, the ejection stability tends to further improve. In addition, the total content of the first pigment and the first binder resin is preferably 6% by mass or more, 8% by mass or more, or 10% by mass or more with respect to the total amount of the first ink. With such a content, the friction fastness of images tends to further improve.

### 1.1.3. Organic Solvent

The first ink contains an organic solvent. Examples of the organic solvent include glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol; glycol mono ethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; nitrogen-containing solvents such as 2-pyrrolidone, N-methyl-2-pyrrolidone, and N-ethyl-2-pyrrolidone; alcohols such as methanol, ethanol, n-propyl alcohol, iso-propyl alcohol, n-butanol, 2-butanol, tert-butanol, iso-butanol, n-pentanol, 2-pentanol, 3-pentanol, and tert-pentanol.

Among these, the organic solvent is preferably glycerin or glycols and more preferably glycerin or triethylene glycol. One type of organic solvent may be used alone, or two or more types may be jointly used.

The content of the organic solvent is preferably 5.0% to 30% by mass, 10% to 25% by mass, or 15% to 20% by mass with respect to the total amount of the first ink. When the content of the organic solvent is within the above-described range, the storage stability and the mechanical stability tend to further improve.

### 1.1.4. Water

The first ink contains water. The content of water is preferably 55% to 85% by mass, 60% to 80% by mass, or 65% to 75% by mass with respect to the total amount of the first ink.

### 1.1.5. pH Adjusting Agent

The first ink may contain a pH adjusting agent. The pH adjusting agent is not particularly limited, but examples thereof include inorganic acids (for example, sulfuric acid, hydrochloric acid, nitric acid, and the like), inorganic bases (for example, lithium hydroxide, sodium hydroxide, potassium hydroxide, ammonia, and the like), organic bases (triethanolamine, diethanolamine, monoethanolamine, and tripropanolamine), and organic acids (for example, adipic acid, citric acid, succinic acid, and the like), and the like. When the first ink contains the pH adjusting agent, the dispersion stability tends to further improve. One type of pH adjusting agent may be used alone, or a mixture of two or more types may be used.

The content of the pH adjusting agent is preferably 0.01% to 1.5% by mass, 0.05% to 1.0% by mass, or 0.1% to 0.75% by mass with respect to the total amount of the first ink. When the content of the pH adjusting agent is within the above-described range, the dispersion stability tends to further improve.

### 1.1.6. Surfactant

The first ink may contain a surfactant. The surfactant is not particularly limited, and examples thereof include an acetylene glycol-based surfactant, a fluorine-based surfactant, and a silicone-based surfactant. One type of surfactant may be used alone, or two or more types may be jointly used.

The acetylene glycol-based surfactant is not particularly limited and is, for example, preferably one or more selected from 2,4,7,9-tetramethyl-5-decyne-4,7-diol and an alkylene oxide adduct of 2,4,7,9-tetramethyl-5-decyne-4,7-diol, and 2,4-dimethyl-5-decyne-4-ol and an alkylene oxide adduct of 2,4-dimethyl-5-decyne-4-ol. The commercially available product of the acetylene glycol-based surfactant is not particularly limited, and examples thereof include OLFINE E1010 and D-10PG (manufactured by Nissin Chemical Co., Ltd.), and the like.

The fluorine-based surfactant is not particularly limited, and examples thereof include perfluoroalkyl sulfonate, perfluoroalkyl carboxylate, perfluoroalkyl phosphate, a perfluoroalkyl ethylene oxide adduct, perfluoroalkyl betaine, and a perfluoroalkylamine oxide compound.

Examples of the silicone-based surfactant include a polysiloxane-based compound, and polyether-modified organosiloxane.

The HLB (hydrophile-lipophile balance) value of the surfactant is preferably 10 or more, more preferably 10to 18, and still more preferably 12 to 16. When the HLB value of the surfactant is within the above-described range, the storage stability and mechanical stability of the ink tend to further improve. The HLB value in the present specification is defined by the Griffin method.

Among these, the acetylene glycol-based surfactant is preferable, and an acetylene glycol-based surfactant having an HLB value of 10 or more is more preferable. When such a surfactant is used, the storage stability and mechanical stability of the ink further improve, and the permeation of the ink into recording media can be curbed, and the black color developability of images tends to further improve.

The content of the surfactant is preferably 0.3% to 2.5% by mass or 0.5% to 2.0% by mass with respect to the total amount of the first ink. When the content of the surfactant is within the above-described range, the black color developability of images and the storage stability and mechanical stability of the ink tend to further improve.

### 1.1.7. Other Components

The first ink may contain, as other components other than the above-described components, for example, a chelating agent, a softener, a solubilizing agent, a viscosity adjuster, an ultraviolet absorber, an antioxidant, a corrosion inhibitor, or the like.

### 1.1.8. pH

The pH of the first ink at 25° C. is preferably 8 to 11, 8.1 to 10, or 8.2 to 9. The acrylic resin particle that is contained in the first ink is anionic, and the pigment may also be anionic. When the pH is 8 or higher, these anionic components are less likely to aggregate, and the ejection stability thus tends to further improve. When the pH is 11 or lower, the anionic components are less likely to be dispersed again after the formation of the coating film, and the friction fastness of images thus tends to further improve.

### 1.2. Second Ink Jet Ink

The second ink contains a second pigment containing a blue pigment, a second binder resin containing anionic urethane resin particles, an organic solvent, and water. From the viewpoint of improving the black color developability of images, the second ink is preferably a blue ink. “Blue ink” refers to an ink that does not fit the above-described definition of “black ink” among inks having a maximum absorption wavelength at 550 to 650 nm in the visible range of 350 to 800 nm when the ink is diluted with water and subjected to spectroscopy.

### 1.2.1. Second Pigment

The second pigment contains a blue pigment. The second pigment may contain a pigment other than the blue pigment, but preferably does not contain a pigment other than the blue pigment. When the second pigment also contains a pigment other than the blue pigment, the blue pigment is preferably contained as a pigment having the largest content on its own in the second pigment.

Examples of the blue pigment include C. I. Pigment Blue 1, 2, 3, 15, 15:1, 15:2, 15:3, 15:34, 15:4, 16, 18, 22, 25, 60, 65, and 66. Among these, the blue pigment preferably contains C. I. Pigment Blue 15:3.

The blue pigment may be self-dispersible or resin-dispersible, but is preferably resin-dispersible. Resin-dispersible blue pigments are likely to improve the friction fastness of images as compared with self-dispersible blue pigments.

The content of the second pigment is 3% by mass or more and preferably 3.5% by mass or more or 4% by mass or more with respect to the total amount of the second ink. With such a content, the black color developability of images tends to further improve. The content of the second pigment is preferably 10% by mass or less or 8% by mass or less with respect to the total amount of the second ink.

### 1.2.2. Second Binder Resin

The second binder resin contains the anionic urethane resin particles as the only resin particles having the largest content in the second binder resin. “The only resin particles having the largest content in the second binder resin” can also be rephrased as “resin particles having the largest content on its own in the second binder resin”. That is, the second binder resin may contain resin particles other than the anionic urethane resin particles, but the content of the resin particles is smaller than the content of the anionic urethane resin particles.

Let's say when the ink contains 50 parts by mass of the anionic urethane resin particles and 50 parts by mass of the resin particles other than the anionic urethane resin particles in 100 parts by mass of the binder resin, there are two resin particles having the largest content, and there is no “only resin particles having the largest content”, and the above-described requirement is thus determined not to be satisfied.

A urethane resin that configures the urethane resin particle is not particularly limited as long as the urethane resin is a resin having a urethane bond in the molecule. Examples of the urethane resin include a polyether-type urethane resin including an ether bond in the main chain, a polyester-type urethane resin including an ester bond in the main chain, a polycarbonate-type urethane resin including a carbonate bond in the main chain, and the like.

The urethane resin particle is anionic, whereby the dispersion stability tends to further improve. The anionic urethane resin particle has, for example, a carboxy group, a sulfo group, a hydroxy group, or the like.

The content of the anionic urethane resin particles is 5% by mass or more with respect to the total amount of the second ink. With such a content, the friction fastness of images tends to further improve. In addition, the content of the anionic urethane resin particles is preferably 12% by mass or less, 10% by mass or less, or 8% by mass or less with respect to the total amount of the second ink. With such a content, the black color developability of images tends to further improve.

The content of the second binder resin is preferably 12% by mass or less, 10% by mass or less, or 8% by mass or less with respect to the total amount of the second ink. With such a content, the ejection stability and the black color developability of images tend to further improve. In addition, the content of the second binder resin is 5% by mass or more with respect to the total amount of the second ink.

The total content of the second pigment and the second binder resin is preferably 15% by mass or less, 13% by mass or less, 11% by mass or less, or 10% by mass or less with respect to the total amount of the second ink. With such a total content, the ejection stability tends to further improve. The total content of the second pigment and the second binder resin is preferably 6% by mass or more, 7% by mass or more, or 8% by mass or more with respect to the total amount of the second ink. With such a content, the black color developability of images and the friction fastness of images tend to further improve.

### 1.2.3. Organic Solvent

The second ink contains an organic solvent. Examples of the organic solvent that is contained in the second ink are the same as those of the organic solvent that is contained in the first ink. The organic solvent that is contained in the second ink may be the same as or different from the organic solvent that is contained in the first ink.

The content of the organic solvent is preferably 5.0% to 30% by mass, 10% to 25% by mass, or 15% to 20% by mass with respect to the total amount of the second ink. When the content of the organic solvent is within the above-described range, the storage stability and the mechanical stability tend to further improve.

### 1.2.4. Water

The second ink contains water. The content of water is preferably 55% to 85% by mass, 60% to 80% by mass, or 65% to 75% by mass with respect to the total amount of the second ink.

### 1.2.5. pH Adjusting Agent

The second ink may contain a pH adjusting agent. Examples of the pH adjusting agent which may be contained in the second ink are the same as those of the pH adjusting agent that is contained in the first ink. The pH adjusting agent that is contained in the second ink may be the same as or different from the pH adjusting agent that is contained in the first ink.

The content of the pH adjusting agent is preferably 0.01% to 1.5% by mass, 0.05% to 1.0% by mass, or 0.1% to 0.75% by mass with respect to the total amount of the second ink. When the content of the pH adjusting agent is within the above-described range, the dispersion stability tends to further improve.

### 1.2.6. Surfactant

The second ink may contain a surfactant. Examples of the surfactant that may be contained in the second ink are the same as those of the surfactant that is contained in the first ink. The surfactant that is contained in the second ink may be the same as or different from the surfactant that is contained in the first ink.

The content of the surfactant is preferably 0.3% to 2.5% by mass or 0.5% to 2.0% by mass with respect to the total amount of the second ink. When the content of the surfactant is within the above-described range, the black color developability of images and the storage stability and mechanical stability of the ink tend to further improve.

### 1.2.7. Other Components

The second ink may contain, as other components other than the above-described components, for example, a chelating agent, a softener, a solubilizing agent, a viscosity adjuster, an ultraviolet absorber, an antioxidant, a corrosion inhibitor, or the like.

### 1.2.8. pH

The pH of the second ink at 25° C. is preferably 8 to 11, 8.2 to 10, or 8.4 to 9.5. The urethane resin particle that is contained in the second ink is anionic, and the pigment may also be anionic. When the pH is 8 or higher, these anionic components are less likely to aggregate, and the ejection stability thus tends to further improve. When the pH is 11 or lower, the anionic components are less likely to be dispersed again after the formation of the coating film, and the friction fastness of images thus tends to further improve.

### 1.3. Method for Producing Ink

The first ink and the second ink can be produced by, for example, mixing the individual components in any order and performing filtration or the like as necessary to remove an impurity, foreign matter, or the like. As a method for mixing the individual components, a method of sequentially adding the individual components into a vessel equipped with a stirring device such as a mechanical stirrer or a magnetic stirrer and stirring and mixing the components is used. Examples of a filtration method include centrifugal filtration, filter filtration, and the like.

### 2. Ink Jet Recording Method

In an ink jet recording method of the present embodiment, a first ink attachment step and a second ink attachment step are performed on the same region on a recording medium using the above-described ink set. The first ink attachment step is a step of ejecting the first ink by an ink jet method and attaching the first ink to the recording medium. The second ink attachment step is a step of ejecting the second ink by an ink jet method and attaching the second ink to the recording medium. When the first ink attachment step and the second ink attachment step are performed on the same region on the recording medium, the urethane resin and the acrylic resin are present in a coating film in a somewhat independent state, respectively. This prevents the urethane resin and the acrylic resin from being mixed too much, whereby the performances of both resins are less likely to be offset, and both the friction fastness and the black color developability are thus satisfied.

The recording medium is not particularly limited, but a fabric is preferable. Fabrics tend to be highly permeable to ink, and it is thus difficult to satisfy both friction fastness and black color developability, but the ink set of the present embodiment enables both the friction fastness and the black color developability to be achieved even when the recording medium is fabric. Fibers that configure the fabric are not particularly limited, and examples thereof include natural fibers and synthetic fibers such as silk, cotton, wool, nylon, polyester, and rayon.

The ink attachment amount in the first ink attachment step is preferably 13 mg/inch² or more, 15 mg/inch² or more, 17 mg/inch² or more, or 19 mg/inch² or more. The ink attachment amount in the first ink attachment step is preferably 40 mg/inch² or less, 35 mg/inch² or less, 30 mg/inch² or less, or 25 mg/inch² or less.

In addition, the ink attachment amount in the second ink attachment step is preferably 6 mg/inch² or more, 8 mg/inch² or more, 10 mg/inch² or more, 12 mg/inch² or more, or 13 mg/inch² or more. The ink attachment amount in the second ink attachment step is preferably 30 mg/inch² or less, 25 mg/inch² or less, 20 mg/inch² or less, or 15 mg/inch² or less.

When the ink attachment amount in the first ink attachment step and the ink attachment amount in the second ink attachment step are the above-described values, the friction fastness and black color developability of images tend to both improve.

The total of the ink attachment amount in the first ink attachment step and the ink attachment amount in the second ink attachment step is preferably 20 to 50 mg/inch², 26 to 40 mg/inch², or 30 to 40 mg/inch². With such a total, the friction fastness and black color developability of images tend to both improve.

The ratio of the ink attachment amount in the first ink attachment step to the ink attachment amount in the second ink attachment step is preferably 1.0 to 2.5, 1.1 to 2.3, 1.2 to 2.2, or 1.3 to 1.8.

The ink attachment amount in the first ink attachment step is preferably larger than the ink attachment amount in the second ink attachment step. With such a content, the black color developability of images tends to further improve.

The first ink attachment step and the second ink attachment step may be performed a plurality of times or only once on the same region on the recording medium. In addition, the first ink attachment step and the second ink attachment step may be performed at the same time or may be performed in any order, for example, alternately.

In the ink jet recording method, an ink other than the first ink or the second ink, or a treatment liquid may be used as long as the effect of the present disclosure is not impaired. The treatment liquid is, for example, a pretreatment liquid, a coating liquid, or the like.

### 3. Ink Jet Recording Device

An ink jet recording device that is used in the ink jet recording method is not particularly limited, and may be, for example, a serial type or a line type. The serial type refers to an ink jet recording device in which a head unit is mounted on a carriage that moves in a main scanning direction (a lateral direction and a widthwise direction of a recording medium), and liquid droplets are ejected from nozzles on the recording medium in association with the movement of the carriage. The line type refers to an ink jet recording device in which a head is fixed, a recording medium is moved along a sub-scanning direction (a longitudinal direction and a transport direction of the recording medium), and liquid droplets are ejected from nozzles of the head in conjunction with the movement.

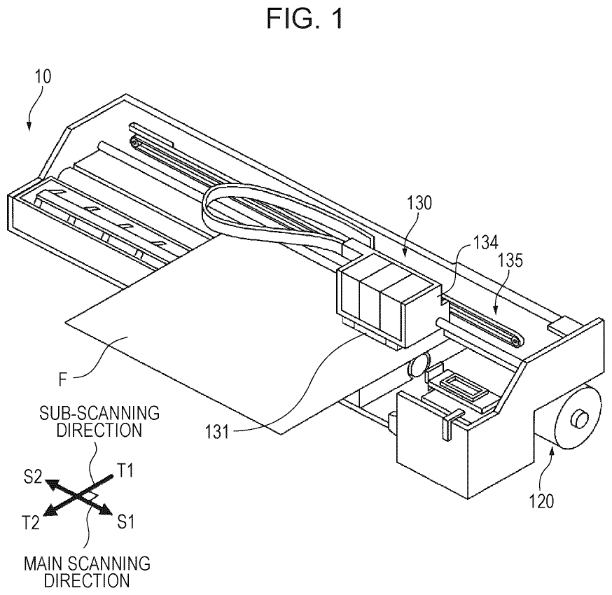

FIG. 1 is a perspective view illustrating an example of the serial type ink jet recording device. An ink jet recording device 10 illustrated in FIG. 1 includes a transport section 120 and a recording section 130. The transport section 120 has a feed roller that transports a recording medium F in a sub-scanning direction T2, and transports the recording medium F to the recording section 130 or discharges the recording medium F after recording. The recording section 130 includes a carriage 134 and a carriage moving mechanism 135 that moves the carriage 134 in main scanning directions S1 and S2. The ink jet head 131 is mounted on the carriage 134. The ink jet head 131 has a nozzle that ejects an ink onto the recording medium F. In association with the movement of the carriage 134, the ink jet head 131 moves in the main scanning directions S1 and S2 (main scanning, pass). The ink jet head 131 ejects the ink onto the recording medium F while moving in the main scanning directions S1 and S2. In the serial type ink jet recording device 10, image formation is performed in a plurality of passes (multi-pass). The recording medium F is transported (sub-scanned) between the passes. In the serial type ink jet recording device 10, for example, main scanning and sub scanning are alternately performed.

### EXAMPLES

Hereinafter, the present disclosure will be more specifically described using examples and comparative examples. The present disclosure is not limited to the following examples.

### 1. Preparation of Pigment Dispersion Liquid

### 1.1. Preparation of Self-Dispersible Black Pigment Dispersion Liquid

500 g of carbon black bulk powder prepared by a furnace method (primary particle diameter=18 nm, BET specific surface area=180 m²/g, DBP absorption amount=186 mL/ 100 g) was added to 3750 g of ion exchange water, and the temperature was raised to 45° C. while performing stirring with a dissolver. After that, 30,000 g of an aqueous solution of sodium hypochlorite (effective chlorine concentration=12%) was added dropwise over 3.5 hours at 45° C. while pulverizing the carbon black bulk powder with a sand mill using zirconia beads having a diameter of 0.8 mm. Subsequently, the pulverization was continued with the sand mill for a further 30 minutes to obtain a treatment liquid containing a self-dispersible carbon black. This treatment liquid was filtered through a 400-mesh wire net to separate the zirconia beads and the unreacted carbon black from the treatment liquid. A 5% potassium hydroxide aqueous solution was added to the treatment liquid obtained through the separation to adjust the pH to 7.5. Desalination and purification were then performed using an ultrafiltration membrane until the electrical conductivity of the liquid reached 1.5 mS/cm. Desalination and purification were further performed using an electrodialyzer until the electrical conductivity of the liquid reached 1.0 mS/cm. The liquid was concentrated until the concentration of the self-dispersible carbon black reached 17% by mass. This concentrate was subjected to centrifugal separation with a centrifugal separator to remove coarse particles and filtered through a 0.6 μm filter. The obtained filtrate was diluted by adding ion exchange water until the concentration of the self-dispersible carbon black reached 15% by mass, and dispersed to obtain a self-dispersible black pigment dispersion liquid.

### 1.2. Preparation of Resin-Dispersible Black Pigment Dispersion Liquid

10 parts by mass of an ammonium salt of a styrene-acrylic acid copolymer (weight-average molecular weight: 10,000) as a dispersant and a polymer component and 55 parts by mass of ion exchange water were added to 15 parts by mass of carbon black and sufficiently mixed together. After that, this mixture was dispersed in a sand mill (manufactured by Yaskawa Electric Corporation) together with glass beads (diameter: 1.7 mm, 1.5 times the amount of the mixture) for two hours. After the dispersion, the glass beads were removed, and a resin-dispersible black pigment dispersion liquid containing the resin-dispersible carbon black was obtained.

### 1.3. Preparation of Resin-Dispersible Cyan Pigment Dispersion Liquid

A resin-dispersible cyan pigment dispersion liquid was obtained by the same method as in the preparation of the above-described resin-dispersible black pigment dispersion liquid except that C. I. Pigment Blue 15:3 was used instead of carbon black. 1.4. Preparation of Resin-Dispersible Yellow Pigment Dispersion Liquid

A resin-dispersible yellow pigment dispersion liquid was obtained by the same method as in the preparation of the above-described resin-dispersible black pigment dispersion liquid except that C. I. Pigment Yellow 180 was used instead of carbon black.

### 1.5. Preparation of Resin-Dispersible Magenta Pigment Dispersion Liquid

A resin-dispersible magenta pigment dispersion liquid was obtained by the same method as in the preparation of the above-described resin-dispersible black pigment dispersion liquid except that C. I. Pigment Red 122 was used instead of carbon black. 2. Preparation of Binder Resin Dispersion Liquid 2.1. Preparation of Urethane-Based Binder Resin Dispersion Liquid

322.2 g of polytetramethylene ether glycol having a number average molecular weight of 1000, 19.7 g of 2,2-dimethylolbutanoic acid, 16.9 g of 1,4-butanediol, 137.9 g of hexamethylene diisocyanate, and 344.0 g of methyl ethyl ketone were charged into a four-neck flask equipped with a stirrer, a cooling tube, a nitrogen introduction tube, and a thermometer, and reacted at 80° C. in a nitrogen gas atmosphere for six hours. After that, a reaction product was cooled to 60° C., 12.5 g of triethyl amine was added thereto, and the components were mixed for 30 minutes at this temperature. The obtained prepolymer was mixed with 1146.7 g of deionized water, and the components were stirred for two hours. After that, methyl ethyl ketone was subjected to solvent removal under reduced pressure at 40° C. As a result, a urethane-based binder resin dispersion liquid containing anionic urethane resin particles having a carboxy group as an acidic group was obtained. The solid content concentration in the obtained dispersion liquid was 30% by mass.

### 2.2. Preparation of Acrylic Binder Resin Dispersion Liquid

2600 g of ion exchange water and 0.5 g of sodium lauryl sulfate were charged into a reaction vessel equipped with a stirrer, a reflux condenser, a dropping device, and a thermometer and heated to 70° C. with nitrogen substitution under stirring. The internal temperature was kept at 70° C., 4 g of potassium persulfate as a polymerization initiator was added thereto and dissolved therein, an emulsion prepared by adding 2 g of acrylamide, 180 g of methyl methacrylate, 25 g of butyl acrylate, and 2 g of methacrylic acid to 300 g of ion exchange water and 0.5 g of sodium lauryl sulfate in advance under stirring was continuously added dropwise into a reaction solution over three hours. After completion of the dropwise addition, aging was performed for one hour. After completion of the aging, an emulsion prepared by adding 30 g of acrylamide, 1200 g of styrene, 200 g of 2-ethylhexyl methacrylate, and 30 g of methacrylic acid to 500 g of ion exchange water and 1.5 g of sodium lauryl sulfate in advance under stirring was continuously added dropwise into the reaction solution over four hours. After completion of the dropwise addition, aging was performed for three hours. The obtained aqueous emulsion was cooled to room temperature, and ion exchange water and sodium hydroxide water were added thereto to adjust the solid content to 30% by mass and the pH to 8. As a result, an acrylic binder resin dispersion liquid containing anionic acrylic resin particles having a carboxy group as an acidic group was obtained.

### 3. Preparation of Inks

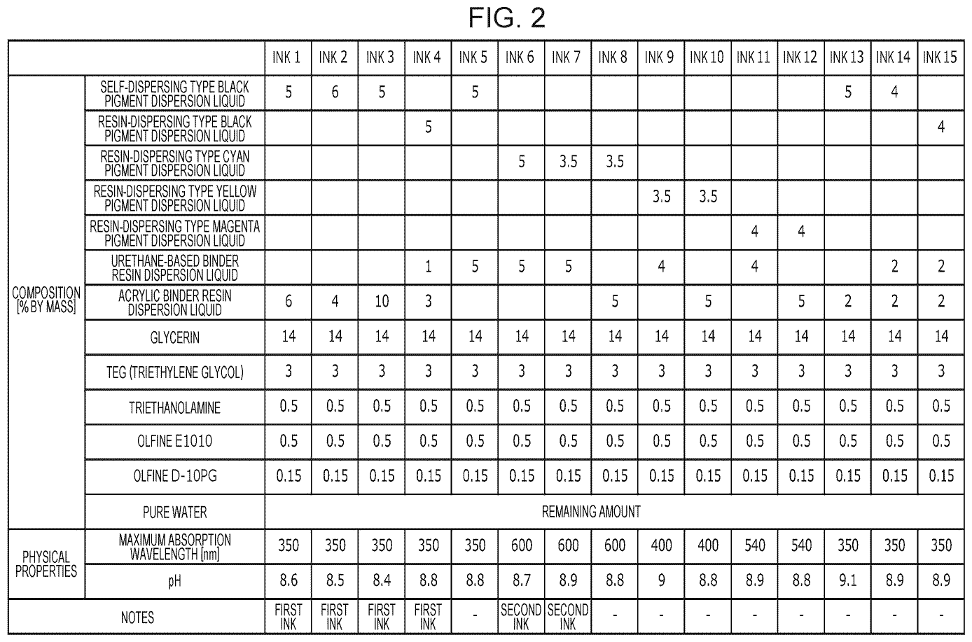

Individual materials were mixed together according to compositions shown in a table of FIG. 2 and sufficiently stirred to obtain inks 1 to 15. The compositions of pigment dispersion liquids shown in the table of FIG. 2 are pigment-equivalent values. The compositions of binder resin dispersion liquids shown in the table of FIG. 2 are binder resin-equivalent values. The units of the compositions shown in the table of FIG. 2 are “% by mass”, and the total of the compositions is 100.0% by mass. OLFINE E1010 and OLFINE D-10PG are both acetylene glycol-based surfactants manufactured by Nissin Chemical Co., Ltd.

### 4. Measurement of Maximum Absorption Wavelength of Ink

Each ink was diluted with pure water at a dilution rate at which the maximum Abs. at 350 to 800 nm reached one in a spectrophotometer (“U-39000H” manufactured by Hitachi High-Tech Science Corporation), and the maximum absorption wavelength was measured. The measurement results were as shown in the table of FIG. 2.

### 5. Measurement of pHs of Inks

The pH of each ink at 25° C. was measured using a desktop pH meter (model number: F-72, manufactured by Horiba, Ltd.). The measurement results were as shown in the table of FIG. 2.

### 6. Ink Jet Recording (Textile Printing)

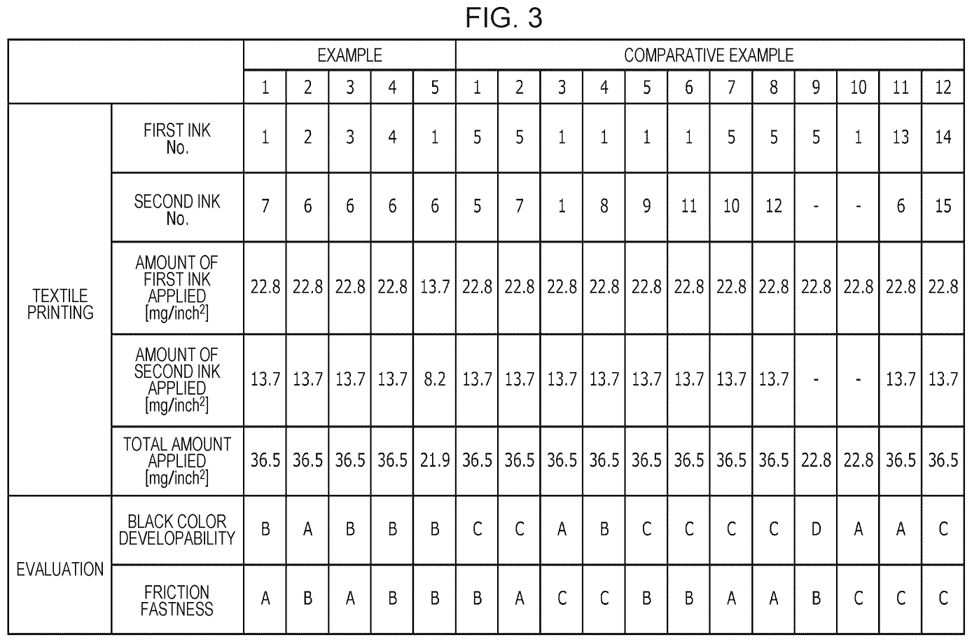

The cartridge of an ink jet printer (manufactured by Seiko Epson Corporation, product name “PX-G930”) was filled with each of the inks prepared above. The ink prepared above was ejected from the head onto pretreated cotton (manufactured by Fortex Co., Ltd., product name “COT-PT”, 100% cotton, basis weight: 130 g/m²) in the same pass using this printer to record a solid image. The printing resolution was set to 1440×720 dpi. The ink laydown was set to 22 ng/dot. The combination of the inks and the amounts of the individual inks applied were as shown in a table of FIG. 3 for each of Examples 1 to 5 and Comparative Examples 1 to 12. The fabric on which the image had been recorded was dried at 160° C. for three minutes to obtain a printed textile.

### 7. Measurement of L*, a*, and b*

L*, a*, and b* of the obtained printed image in the Lab color space were measured. As a result, in the ink of each example containing the black pigment dispersion liquid, L* was 50 or less, a* was 10 or less, and b* was 10 or less. On the other hand, in the ink of each example not containing the black pigment dispersion liquid, at least one of L*, a*, and b* was not in the above-described range.

### 8. Evaluation

### 8.1. Black Color Developability (Optical Density of Black)

The optical density (OD, Status E) of black on the printed image was measured for the printed textile prepared above and further determined according to the following criteria. The black color developability was evaluated as described above.
A: The OD of black on the printed image is 1.60 or more.
B: The OD of black on the printed image is 1.56 or more and less than 1.60.
C: The OD of black on the printed image is 1.52 or more and less than 1.56.
D: The OD of black on the printed image is less than 1.52.

### 8.2. Friction Fastness (Wet Friction Fastness)

With respect to the printed textile prepared above, the image on the printed textile was rubbed with shirting (white cotton fabric) 10 times with a load of 9 N using a crock meter (FI-306, manufactured by Tester Sangyo Co., Ltd.), the shirting being wetted with pure water to be put into a wet state of approximately 100%. After that, for a region contaminated with the ink on the rubbed shirting, the optical density (OD, Status E) of black was measured using a colorimeter (FD-7, manufactured by Konica Minolta Inc.) and further determined according to the following criteria. The friction fastness was evaluated as described above.
A: The OD of black on the contaminated region is 0.5 or less.
B: The OD of black on the contaminated region is more than 0.5 and 0.6 or less.
C: The OD of black on the contaminated region is more than 0.6.

### 9. Evaluation Results

The evaluation results are shown in the table of FIG. 3. From these results, it is found that the ink set of the present embodiment enables the formation of an image in which both the friction fastness and the black color developability are satisfied.

What is claimed is:

1. An ink jet ink set comprising:
a first ink jet ink; and
a second ink jet ink, wherein
the first ink jet ink contains a first pigment containing a black pigment, a first binder resin containing anionic acrylic resin particles, an organic solvent, and water,
a content of the first pigment is 3% by mass or more with respect to a total amount of the first ink jet ink,
a content of the anionic acrylic resin particles is 3% by mass or more with respect to the total amount of the first ink jet ink,
the anionic acrylic resin particles are only resin particles having a largest content in the first binder resin,
the second ink jet ink contains a second pigment containing a blue pigment, a second binder resin containing anionic urethane resin particles, an organic solvent, and water,
a content of the second pigment is 3% by mass or more with respect to a total amount of the second ink jet ink,
a content of the anionic urethane resin particles is 5% by mass or more with respect to the total amount of the second ink jet ink, and
the anionic urethane resin particles are only resin particles having a largest content in the second binder resin.

2. The ink jet ink set according to claim 1, wherein
a pH of the first ink jet ink at 25° C. is 8 to 11, and
a pH of the second ink jet ink at 25° C. is 8 to 11.

3. The ink jet ink set according to claim 1, wherein
a content of the first binder resin is 10% by mass or less with respect to the total amount of the first ink jet ink, and
a content of the second binder resin is 10% by mass or less with respect to the total amount of the second ink jet ink.

4. The ink jet ink set according to claim 1, wherein
the blue pigment contains C. I. Pigment Blue 15:3.

5. The ink jet ink set according to claim 1, wherein
a total content of the first pigment and the first binder resin is 13% by mass or less with respect to the total amount of the first ink jet ink, and
a total content of the second pigment and the second binder resin is 13% by mass or less with respect to the total amount of the second ink jet ink.

6. The ink jet ink set according to claim 1, wherein
the ink jet ink set is for textile printing.

7. The ink jet ink set according to claim 1, wherein
the black pigment is a self-dispersible carbon black.

8. The ink jet ink set according to claim 1, wherein
the blue pigment is a resin-dispersible pigment.

9. An ink jet recording method using the ink jet ink set according to claim 1, the method comprising:
a first ink attachment step of ejecting a first ink jet ink by an ink jet method and attaching the first ink jet ink to a recording medium; and
a second ink attachment step of ejecting a second ink jet ink by the ink jet method and attaching the second ink jet ink to the recording medium, wherein
the first ink attachment step and the second ink attachment step are performed on the same region on the recording medium.

10. The ink jet recording method according to claim 9, wherein
an ink attachment amount in the first ink attachment step is 13 mg/inch² or more,
an ink attachment amount in the second ink attachment step is 13 mg/inch² or more, and
a total of the ink attachment amount in the first ink attachment step and the ink attachment amount in the second ink attachment step is 26 to 40 mg/inch².

11. The ink jet recording method according to claim 9, wherein
an ink attachment amount in the first ink attachment step is larger than an ink attachment amount in the second ink attachment step.
